(19) United States
(12) Patent Application Publication
(10) Pub. No.: US 2006/0079305 A1
(43) Pub. Date: Apr. 13, 2006

(54) Mobile station cover and welding method

(75) Inventors: Andrew Gartrell, Tarzana, CA (US); Maree Park, Marina del Rey, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 11/280,001

(22) Filed: Nov. 16, 2005

Related U.S. Application Data
(63) Continuation-in-part of application No. 10/783,228, filed on Feb. 19, 2004, now Pat. No. 6,999,805.

(51) Int. Cl. H04M 1/00; H04B 1/38

(52) U.S. Cl. 455/575.8; 455/575.1; 455/90.3; 379/433.01

(57) ABSTRACT

Various embodiments are directed to an improved mobile station cover assembly adapted for at least partially enclosing a wireless telecommunications signal receiving and generating assembly. In one embodiment, the cover assembly includes a belt adapted to receive one or more weldable articles. The belt has a first end, a second end and a pair of side edges. The pair of side edges are laterally spaced from each other and extend between the first and second ends. Also included in the belt are first and second portions wherein the first portion is adjacent the first end and the second portion is adjacent the second end. Positioned between the first and second portions is a foldable portion. The foldable portion extends between the side edges and allows the first and second portions to be opened or closed when moved about the foldable portion. In this manner, the first and second portions may be opened or separated to at least partially envelop, in overlying contact with, the signal receiving and generating assembly.

### CROSS REFERENCE TO RELATED APPLICATION

This application is a continuation-in-part of copending U.S. patent application Ser. No. 10/783,228 filed Feb. 19, 2004, which is incorporated herein by reference.

### BACKGROUND

1. Field

The invention is related to the use of covers for mobile stations (such as mobile telephones), and more particularly to methods of welding articles such as logos, text, graphics, functional components, etc., to interchangeable covers that protect and allow aesthetic customization of a mobile station.

2. Description of Related Art

Participants in the mobile telephone industry are in a constant search to differentiate their telephones by making them easier to use and more aesthetically appealing. For example, mobile telephones have been developed with easily interchangeable covers. An interchangeable cover allows the user to change the appearance of the phone as desired, such as by matching the cover to an outfit or perhaps using seasonal or festive covers.

In addition to aesthetic appearance, high-volume manufacturability, cost, and durability of the mobile telephone are also a concern. Originally, mobile telephones were housed in large protective cases and included large battery power supplies. Steady improvements in mobile telephone construction have resulted in more lightweight and low-cost telephones. Many mobile telephones have housings constructed of hard plastic materials, such as thermoplastic materials that are heated and molded into a container for the electronic components of the telephone. Other more recently developed mobile phones adopt thin metal housings to provide a perceived “premium quality” slimmer appearance. Although such materials are an effective guard against routine impacts from drops and other blows, extraordinary impacts can result in permanent deformation of the housing.

As an additional guard against impacts, a separate cover constructed of leather or textile materials is often employed. Such materials are typically softer and more energy absorbent, dampening the shock of an impact and protecting the telephone housing from dents or fracture. Traditionally, portions of the cover may be printed with logos, text, graphics, or other indicia for branding or other purposes. However, conventional printing processes have a number of drawbacks. For example, indicia formed by conventional printing processes have a poor resistance to wear and are generally flat, thus, providing little enhancement to the tactile “feel” of the mobile station. Finally, conventional covers (whether printed or not) generally appear to consumers as generic, relatively bland protective sleeves rather than as highly customizable augmentations of a factory-equipped mobile telephone.

Therefore, it would be advantageous to provide a mobile station cover that is easily removed and replaceable for aesthetic or functional customization of the mobile station. The cover should be durable and readily accept raised or three-dimensional logos or other components that enhance the look, feel, or operation of the mobile station. The cover should protect the mobile station against impacts and have a premium, highly-customizable, appearance. It is further desirable for the cover to be interchangeable among mobile stations without interfering with the functionality of the various user-interfaces, such as the display and keypad. Finally, the mobile station cover should be readily manufacturable for high volume applications and should accommodate flexibility in branding and warehousing of generic covers.

### BRIEF SUMMARY

The above needs are addressed and other advantages are provided by an improved mobile station cover assembly adapted for at least partially enclosing a wireless telecommunications signal receiving and generating assembly. In one embodiment, the cover assembly includes a belt adapted to receive one or more weldable articles. The belt has a first end, a second end and a pair of side edges. The pair of side edges are laterally spaced from each other and extend between the first and second ends. Also included in the belt are first and second portions wherein the first portion is adjacent the first end and the second portion is adjacent the second end. Positioned between the first and second portions is a foldable portion. The foldable portion extends between the side edges and allows the first and second portions to be opened or closed when moved about the foldable portion. In this manner, the first and second portions may be opened or separated to at least partially envelop, in overlying contact with, the signal receiving and generating assembly.

As referenced above, the belt portion of the cover is adapted to receive one or more weldable articles. The weldable articles may be fused to the belt by high frequency and/or ultrasonic welding processes. In high frequency welding embodiments, at least a portion of the belt and the weldable articles are comprised of polar plastic materials such as polyvinyl chloride, polyurethane, poly(methyl methacrylate), polyamide, polycarbonate, etc. In ultrasonic welding embodiments, opposite portions of the belt and of the weldable articles may be structured to define an ultrasonic weld joint (e.g., butt-joint, shear joint, etc.) as described in further detail below. In each of the embodiments referenced above, portions of the belt and the weldable articles are melted and compressed together forming a welded joint.

One embodiment of the invention is directed to a method of manufacturing a mobile station cover, the method comprising: forming a belt having a first portion, a second portion, and a foldable portion defined therebetween, wherein the foldable portion is adapted to accommodate separation of the first portion from the second portion in an open position adapted to receive and at least partially envelop a wireless telecommunication signal receiving and generating assembly; and welding a weldable article to the belt. In one embodiment the welding step is a high frequency welding step comprising the steps of positioning a weld area of the belt and a weld area of the weldable article between a die and a capacitor plate, applying an oscillating electrical field to melt the weld area of the belt and the weld area of the weldable article, and compressing the belt and the weldable article between the die and the capacitor plate to fuse the weld area of the belt to the weld area of the weldable article. In still another embodiment, the welding step is an ultrasonic welding step comprising the steps of positioning a weld area of the belt and a weld area of the weldable article between a horn structured to generate an acoustic vibration and an anvil, applying an acoustic vibration generated by the horn to melt the weld area of the belt and the weld area of the weldable article, and compressing the belt and the weldable article between the horn and the anvil to fuse the weld area of the belt to the weld area of the weldable article.

Covers having weldable articles fused thereto according to various embodiments of the invention may be readily attached and removed from the signal receiving and generating assembly, allowing quick exchange with other covers to change the appearance of the mobile station. The utility and appearance of the covers themselves is enhanced by the welded articles fused thereto. In one embodiment, aesthetically pleasing articles (logos, colored panels, etc.) may be welded to the cover to provide enhanced customization of the mobile station's appearance. In such embodiments, the aesthetic articles may have one or more three-dimensional portions to improve the tactile “feel” of the mobile station. This result stands in sharp contrast to the two-dimensional, easily worn or faded decoration available by prior art printing techniques. In other embodiments, functional articles such as keymats, padding panels, and the like may be welded to the cover for enhancing the operation and/or impact resistance of the mobile station. Such articles may be strategically placed on belts in various embodiments to fit differing mobile station structures without interfering with standard mobile station components (e.g, display, speaker, microphone, etc.).

The weldable articles may be fused to the belt portion of the cover by high frequency and ultrasonic welding processes. The relative efficiency and simplicity of such welding processes allow for rapid customization of a mobile station cover. Advantageously, such customization may occur at any point during the cover manufacturing process. For example, in one embodiment, mobile station covers may be produced in a “generic” form and stored in bulk, and then customized for specific applications or distribution channels at a later date by welding various weldable articles to the cover. In this regard, mobile station cover manufacturer's are provided enhanced warehousing flexibility over the prior art.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a mobile station of one embodiment of the invention;

FIG. 2 is a perspective view of a mobile station cover having a belt portion opened to receive a wireless telecommunications signal receiving and generating assembly of the mobile station shown in FIG. 1;

FIGS. 3A-3C depict a belt blank adapted to receive one or more weldable articles and thereby forming a belt portion of a mobile station cover according to one embodiment of the invention, wherein FIG. 3A is a plan view of an interior surface of the belt blank, FIG. 3B is a side view of the belt blank, and FIG. 3C is a plan view of an exterior surface of the belt blank;

FIG. 4 is a detail view of a high frequency welding station for securing a weldable article to a belt blank in accordance with one embodiment of the invention;

FIG. 5A is a detail view of a high frequency welding station for securing a weldable article to a belt blank in accordance with another embodiment of the invention;

FIG. 5B is a detail view of the high frequency welding station of FIG. 5A, wherein the weldable article has been fused to the belt blank in accordance with one embodiment of the invention;

FIG. 6A is a detail view of an ultrasonic welding station for securing a weldable article to a belt blank in accordance with one embodiment of the invention;

FIG. 6B is a detail view of the ultrasonic welding station of FIG. 7A, wherein the weldable article has been fused to the belt blank in accordance with one embodiment of the invention; and

FIGS. 7A-7C depict a cover assembly having a belt portion wherein one or more welded articles are fused thereto in accordance with one embodiment of the invention, wherein FIG. 7A is a plan view of an interior surface of the cover assembly, FIG. 7B is a side view of the cover assembly, and FIG. 7C is a plan view of an exterior surface of the cover assembly.

### DETAILED DESCRIPTION

The invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

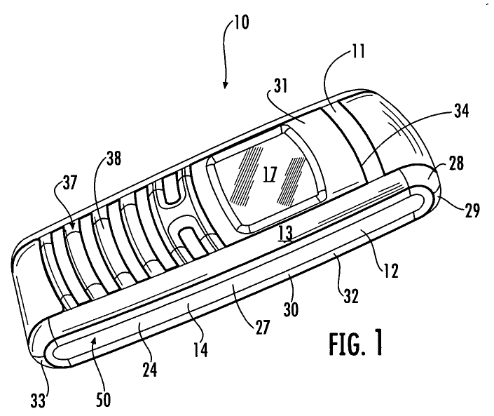

FIG. 1 depicts a mobile station 10 having a cover assembly 11 formed at least partially using high frequency or ultrasonic welding methods according to various embodiments of the invention. As will be discussed in greater detail below, high frequency (“HF”) or radio frequency (“RF”) welding is a process adapted for fusing together polar plastics such as polyvinyl chloride, polyurethane, poly(methyl methacrylate), polyamide, polycarbonate, etc. Alternatively, ultrasonic welding is a process whereby low amplitude acoustic vibration is used to fuse together a relatively wider range of materials including thermoplastic polymers and even metals. In the depicted embodiment, HF or ultrasonic welding is used to attach one or more weldable articles to a belt portion 13 of the mobile station cover assembly 11 to enhance the look, feel, and/or operation of the mobile station 10.

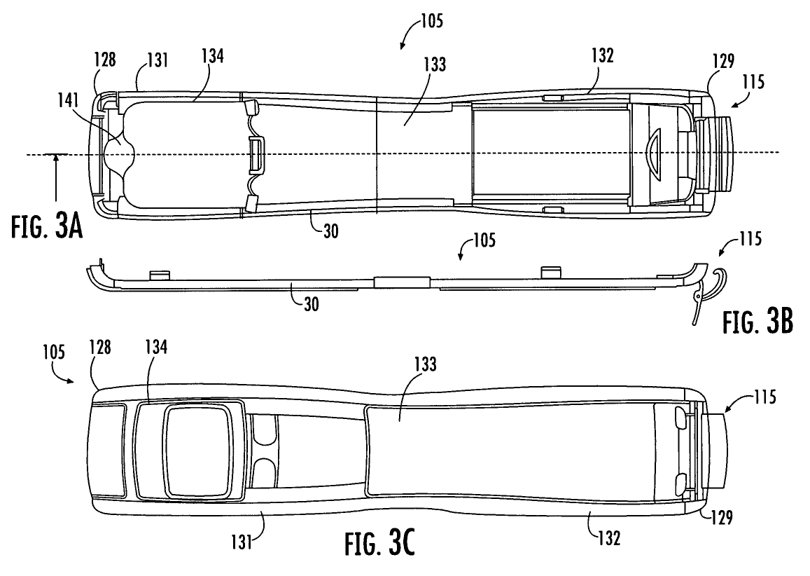

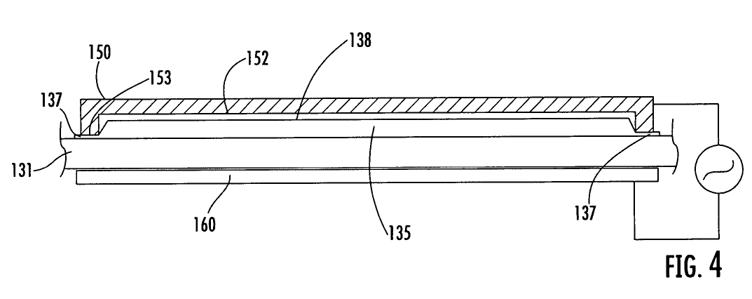

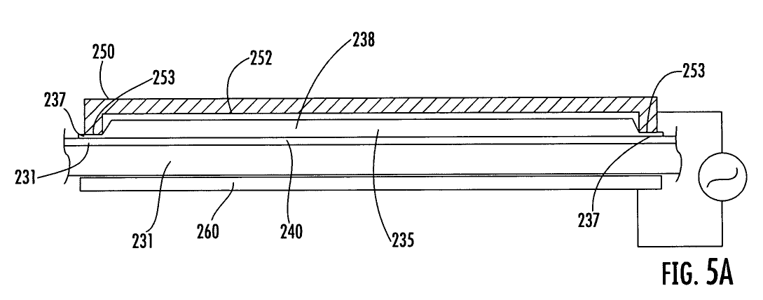

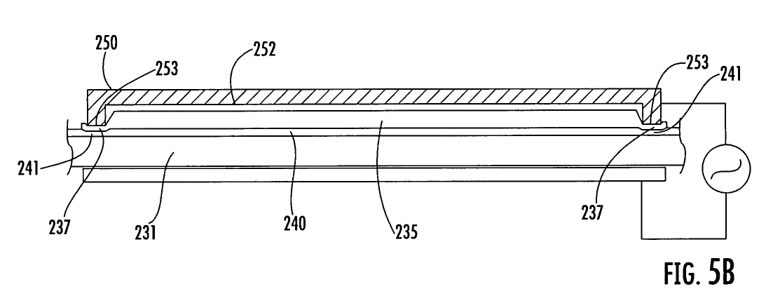

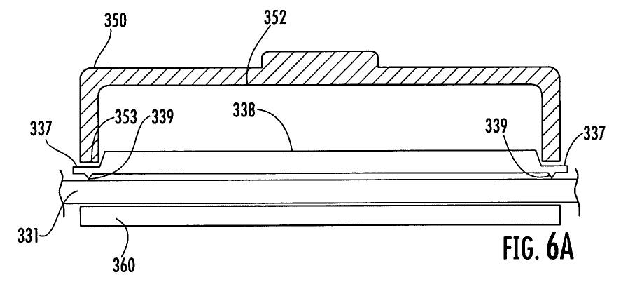

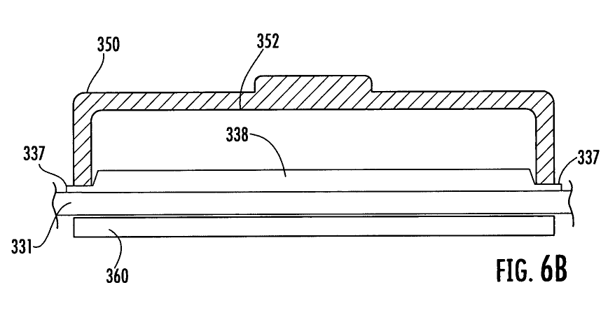

As will be apparent to one of ordinary skill in the art, FIGS. 1, 2, and 7 illustrate an exemplary mobile station and corresponding mobile station covers that are formed using HF and/or ultrasonic welding techniques in accordance with various embodiments of the invention. High frequency welding processes according to several embodiments are illustrated by FIGS. 4, 5A, and 5B, while ultrasonic welding processes according to other embodiments are illustrated by FIGS. 6A and 6B. FIGS. 3A-3C depict a belt portion of a mobile station cover prior to the attachment of one or more weldable articles according to various embodiments of the invention.

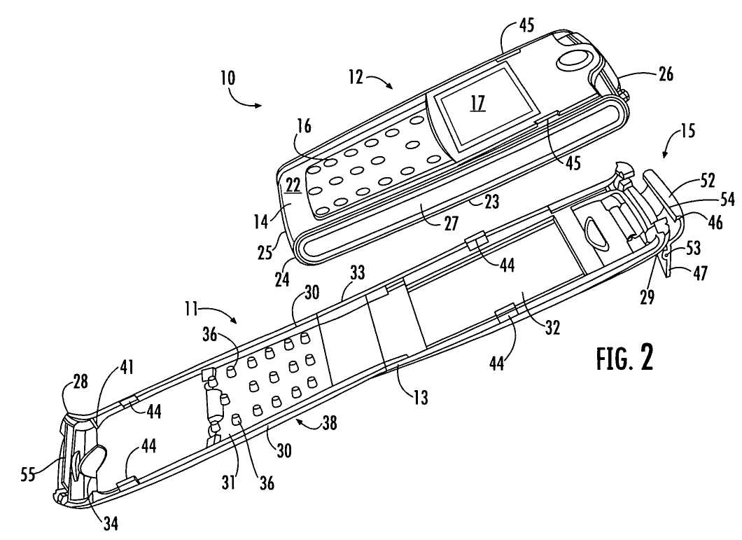

As shown collectively in FIGS. 1 and 2, mobile stations may include a cover assembly 11 and a wireless telecommunications signal receiving and generating assembly 12. Such cover assemblies are described in detail by commonly owned U.S. patent application Ser. No. 10/783,228, which is incorporated by reference herein in its entirety. The depicted cover assembly 11 includes a belt 13 that extends around an outer housing 14 of the signal receiving and generating assembly 12 and is secured thereabout using a connector 15. Advantageously, the cover assembly 11 protects the signal receiving and generating assembly 12 during use and remains easily removable and exchangeable with other cover assemblies to allow customization of the appearance of the mobile station 10. As discussed in detail below, mobile station covers may include belt portions that are adapted to receive weldable articles containing aesthetic components such as text, logos, graphics, etc., and functional components such as keymats, impact-resistant padding, etc. Mobile station covers produced by various techniques described herein provide low cost mobile station covers for enhancing the durability and aesthetic customization of a mobile station.

It should be understood that the mobile telephone and cover illustrated and hereinafter described are merely illustrative of one type of mobile station and cover that would benefit from the invention and, therefore, should not be taken to limit the scope of the invention. For example, other types of mobile stations, such as portable digital assistants (PDAs), pagers, laptop computers and other types of voice and text communications systems can readily employ covers having weldable articles consistent with various embodiments of the invention. Moreover, the system and method of the invention will be primarily described in conjunction with mobile communications applications. However, the mobile station covers and methods for welding articles to the same as described herein can be used to produce covers adapted for at least partially enclosing a variety of devices, both inside and outside the mobile communications industries.

As shown in FIG. 2, the depicted signal receiving and generating assembly 12 includes the outer housing 14, a plurality of key contacts 16, a display 17 and an interface jack 18. The signal receiving and generating assembly 12 also includes other, conventional components (battery, microphone, earpiece, processor, printed wiring board, transmitter, receiver, etc.) necessary for the mobile station to receive, process, and generate wireless communications signals. However, these remaining components are conventionally known to one of skill in the art and are therefore not described or shown herein in additional detail.

In the illustrated embodiment, the housing 14 generally has a rectangular shape with a front surface 22, a back surface 23 and a peripheral surface 24 that extends between the front and back surfaces. The front surface defines a plurality of openings, including an opening through which the display 17 extends and openings through which the plurality of key contacts 16 extend, or are accessible. The back surface 23 does not define openings in the illustrated embodiment. However, various other openings may be defined in the back and other surfaces of the housing depending upon the type of mobile station and the type of access needed to the electronic, and other components, housed therein. For instance, a mobile station of the invention that includes a headphone jack may have an opening defined in a surface of its housing 14 through which the headphone jack can be accessed.

The peripheral surface 24 of the housing 14 may include top and bottom portions 25, 26 (wherein “top” and “bottom” are defined with respect to the orientation of the mobile station 10 in the Figures) and side portions 27. In various cover applications, the belt 13 extends over the entire top and bottom portions 25, 26, but leaves the side portions mostly uncovered. The top and bottom portions 25, 26 of the peripheral surface 24 have a semicircular, or rounded, shape and are on opposite ends of the housing 14. Advantageously, the rounded shape of the top and bottom portions promotes conforming contact of the belt 13 against the housing 14. The side portions 27 of the peripheral surface 24 typically have a planar shape and are also on opposite sides of the housing.

The key contacts 16 are positioned in an array on the front surface 22 of the housing 14 and each of the key contacts performs one or more allotted input functions, such as entry of a number for dialing or paging through menu selections. The key contacts 16 may either be accessible through openings in the outer housing 14, or the outer housing itself may have part of its front surface 22 formed of a printed wiring board directly supporting the key contacts 16. Such printed wiring boards typically employ metal dome contacts to register depression of overlying keys. Movement of such dome contacts upon the application of pressure is preferably in fractions of a millimeter, allowing relatively light pressure to register an input.

It should be noted that in addition to the metal dome type contacts 16, other key contact devices could be used to sense an application of pressure. For instance, piezoelectric tablets could be positioned so as to record key depressions. Therefore, the term “key contacts” as used herein in reference to the wireless signal processing assembly, and its component parts, refers to a device, or collection of devices, or other structure capable of recording the application of pressure, typically produced by the depression or actuation of one or more keys, for the purpose of registering an input to the processing assembly.

The depicted belt 13 includes a first end 28, a second end 29 and a pair of side edges 30. The side edges 30 extend between the ends 28, 29 and the edges and ends collectively define a belt of material that can be secured around the signal receiving and generating assembly 12. The belt 13 provides additional protection and durability to the signal receiving and generating assembly 12, and allows easy exchangeability with other belts for changes in the aesthetic appearance of the mobile station 10.

The belt 13 includes a first portion 31 adjacent the first end 28 and a second portion 32 adjacent the second end 29. A foldable portion 33 of the belt 13 separates the first and second portions 31, 32. As a result, the first portion 31 extends between the first end 28, the foldable portion 33 and the side edges 30. The second portion 32 extends between the second end 29, the foldable portion 33 and the side edges 30. The belt 13 also may also include a keypad 37 having keys 38 on its outer surface and corresponding frusto-conical shaped plungers 36 on its inner surface. Each of the plungers 36 is positioned to correspond to respective ones of the key contacts 16 and extend through openings defined in the housing 14. The belt 13 may optionally include clip members 44 for securing the belt 13 to one or more clip apertures 45 defined in the housing 14. In alternative embodiments, other fasters may be used to secure the belt as will be apparent to one of ordinary skill in the art.

Belts 13 of the type depicted in FIGS. 1 and 2 may be produced by a variety of techniques. In one embodiment, belts 13 are produced from a belt blank 105 as shown in FIGS. 3A-3C. The term belt blank 105 generally refers to one or more base strips of material that undergo welding and optionally other processing operations to become a belt 13 or belt portion of a mobile station cover. Belt blanks 105 may be comprised of various materials including one, or combinations of, textile materials (e.g., leather, woven or knitted materials), thermoplastics, rubber, silicone, vinyl, etc., but are preferably constructed of a single material having elastic properties. Materials having elastic properties have the advantage of dampening and absorbing energy from the types of sudden impacts that break open relatively hard plastic housings and damage the delicate electronics held inside the housing. In addition, elastic materials facilitate attachment of the belt around the signal receiving and generating assembly 12 by allowing the ends 28, 29 to be drawn together. Further, belt blank materials can be selected to be aesthetically pleasing, such as by including patterns, luminescence, reflective qualities, colors, images, indicia or other visible depictions or characteristics. Examples of preferred materials include a two-shot elastomer wherein the color and material properties can be varied at specific locations along the belt. As another example, the belt blank may be constructed of fabric having molded or rubber trim.

In the illustrated embodiment, the first and second portions 131, 132 of the belt blank 105 are both generally flat and have a similar rectangular shape. The first portion 131 is sized and shaped to overlie the entire front surface 22 of the housing 14 (as shown in FIG. 2), while the second portion 132 is sized and shaped to overlie the entire back surface 23 of the housing 14. The depicted belt blank 105 defines a display opening 134 for receiving an LCD or other similar mobile station display (not shown). The belt blank 105 may define additional apertures such as audio openings 141 and the like, which provide access to audio output speakers and other components that are preferably left uncovered.

As suggested above, belt blanks 105 are base strips of material that are adapted to receive one or more weldable articles. Weldable articles may include a variety of aesthetic and functional components that are fused to a belt blank 105 via HF or ultrasonic welding processes. Aesthetic components may include indicia such as text, graphics, logos, etc., while functional components may include trim portions, LCD or other impact-resistant padding portions, keymats, and the like. FIGS. 4, 5A, and 5B depict a HF welding process in accordance with one embodiment of the invention. HF welding is a process whereby an applied electrical field is used to fuse adjacent layers of polar plastics such as polyvinyl chloride, polyurethane, poly(methyl methacrylate), polyamide, polycarbonate, and other similar materials. When an electrical field is applied adjacent a polar material, the molecules in the material align themselves according to the potential of the electrical field. The fluctuation of the field induces fluctuations in the molecular orientation of the material, causing internal friction and heat.

For the purposes of the foregoing specification and appended claims the term “polar plastics” refers to polymer materials having polar dipoles that move in the presence of an electric field and further tend to align with an applied electric field. Such polar dipoles may be created by imperfect covalent bonds or an imbalance of electrons in the polymer molecule.

To perform HF welding, two layers of polar plastics are positioned in face to face contact between die platens that act as capacitor plates. An oscillating electrical field is applied to the polar plastic layers between the die platens. The die platens may comprise brass, steel, aluminum/magnesium, or other similar materials. To perform the weld, the die platens are compressed together in a localized area. The combined pressure and localized melting of the opposed polar plastic layers produces a welded bond in the materials between the die platens.

In one embodiment, as shown in FIG. 4, HF welding is used to bond a logo mat 135 to a first portion 131 of a belt blank. Although the depicted embodiment illustrates an HF welding operation for bonding a logo mat to the first portion of a belt blank it will be apparent to one of ordinary skill in the art that the invention may be applied to bond any weldable article (e.g., graphics, logos, trim portions, keymats, aesthetic components, etc.) to any surface of the belt portion (e.g., first portion, second portion, exterior surface, interior surface, etc.) of a mobile station cover. In the depicted embodiment, the logo mat 135 includes a raised logo portion 138 and a perimeter tab portion 137. Such raised logo portions 138 may provide a three-dimensional tactile feel to the logo in contrast to logos or text produced via prior art printing techniques. The depicted logo mat 135 is comprised at least partially of a polar material such as thermoplastic urethane (TPU). Similarly, the first portion 131 of the depicted belt blank 105 is comprised of a polar plastic such as vinyl. The logo mat 135 is positioned in face to face contact with the first portion 131 of the belt blank between a die 150 and a capacitor plate 160 as shown. In the depicted embodiment, the die 150 is shaped to define a cavity 152 for receiving one or more raised portions of the logo mat 135. Although depicted as having a generally uniform depth, it is noted that die cavities used in connection with various embodiments of the invention may be configured to mirror the topography of a selected one or group of weldable articles. In this regard, dies according to various embodiments of the invention may define one or more cavities of widely varying topography.

In one embodiment, the die 150 includes one or more electrode portions 153 defined about the perimeter of one or more cavities 152 that generally serve as welding electrodes. The electrode portions 153 operate in combination with the capacitor plate 160 to convert an oscillating electrical current into an oscillating electric field that is applied to the logo mat 135 and the belt blank 105. The oscillating electric field creates localized melting of the logo mat 135 and the first portion 131 of the belt blank 105 at weld areas defined between the planar portions 153 of the die 150 and the capacitor plate 160 as shown. As the localized weld areas are melted, the die 150 and capacitor plate 160 are compressed together, thus, fusing the logo mat 135 and the first portion 131 of the belt blank 105.

As suggested above, mobile station covers provide durability and a means for aesthetic customization of the mobile station. Therefore, it may be desirable to manufacture the base strip of the cover, i.e., the belt or belt blank 205, from a variety of durable or aesthetically pleasing materials including non-polar plastic materials. For example, as illustrated in FIGS. 5A-5B, it may be desirable to produce a belt blank 205 comprised of non-polar plastic materials such as leather. In such embodiments, at least a portion of the belt blank 205 is coated or laminated by a weld layer 240 comprised at least partially of polar plastic materials. In the depicted embodiment, the weld layer 240 is comprised of TPU. A weldable article, such as the depicted logo mat 235, may then be HF welded to the weld layer 240 as shown collectively in FIGS. 5A and 5B. At least a portion of the depicted logo mat 235 is comprised of a polar material such as silicon.

The logo mat 235 depicted in FIG. 5A is placed in face contact with the weld layer 240 of the belt blank between a die 250 and a capacitor plate 260 as shown. Once again, as described above, the logo mat 235 includes a raised logo portion 238 and a perimeter tab portion 237. In other embodiments, differently configured logo mats, text mats, and other weldable articles may be fused to one or more weld layers laminated overlying belts as will be apparent to one of ordinary skill in the art. In the depicted embodiment, the die 250 includes electrode portions 253 disposed proximate a cavity 252 structured for receiving the raised logo portion 238 of the logo mat 235. The electrode portions 253 of the die 250 and the capacitor plate 260 operate to apply an oscillating electric field to the logo mat 235 and the weld layer 240. As shown in greater detail by FIG. 6B, the oscillating electric field creates localized melting of the perimeter tab portion 237 of the logo mat 235. Melting also occurs in weld areas 241 of the weld layer 240. To complete the weld, the die 250 and capacitor plate 260 are compressed together, thus, fusing the molten perimeter tab portion 237 of the logo mat 235 and the molten weld areas 241 of the weld layer 240 as shown.

In another embodiment, as shown in FIGS. 6A and 6B, ultrasonic welding may be used to bond various weldable articles to belts or other portions of a mobile station cover. Ultrasonic welding is a bonding technique whereby two pieces of plastic or metal are joined together seamlessly through high-frequency acoustic vibrations. In various embodiments, a portion of a mobile station cover such as a belt or belt blank is placed on a fixed anvil. A weldable article is then placed atop the belt or belt blank. An ultrasonic welding horn (“horn”) connected to a transducer is lowered down onto the weldable article, and a rapid (generally about 20,000 KHz) low-amplitude acoustic vibration is applied to a small welding zone. The acoustic energy is converted into heat energy by friction, and the parts are welded together generally in less than a second.

In the depicted embodiment, the weldable article is once again a logo mat 335 having a raised logo portion 338 and a perimeter tab portion 337. In other embodiments, other weldable articles may be used. The raised logo portion 338 of the logo mat 335 advantageously provides a three-dimensional feel to the logo in contrast to logos or text produced via prior art printing techniques. The depicted logo mat 335 is structured for ultrasonic welding to a first portion of a belt blank 331 in accordance with one embodiment of the invention. In other embodiments, logo mats or other weldable articles may be ultrasonically welded to other surfaces of the belt portion of a mobile station cover. The depicted logo mat 335 and first portion of the belt blank 331 are sandwiched between a horn 350 and an anvil 360. In the depicted embodiment, the horn 350 is shaped to define a cavity 352 for receiving the raised logo portion 338 of the logo mat 335. The horn 350 includes a rim portion 353 defined about the cavity 352. The horn 350 is structured to apply a rapid, low amplitude acoustic vibration to a welding zone disposed between the rim portion 353 and the anvil 360.

Ultrasonic welding processes may be enhanced, to some degree, based upon the structure of the joint defined between the two surfaces that are intended for welding. In the depicted embodiment, a butt-joint is provided for fusing the perimeter tab portion 337 of the logo mat 335 to the first portion of the belt blank 331. More particularly, the perimeter tab portion 337 includes a triangular-shaped weld ridge 339 for focusing the acoustic waves applied by the horn 350 into a very small area. Such focused acoustic waves cause rapid frictional interference between the triangular-shaped weld ridge 339 and the first portion of the belt blank 331 thereby creating localized melting between the perimeter tab portion 337 of the logo mat 335 and the first portion of the belt blank 331. The melting occurs in weld areas disposed on the perimeter tab portion 337 of the logo mat 335 and on the first portion of the belt blank 331 respectively. To complete the weld, the horn 350 and anvil 360 are compressed together, thus, fusing the weld area of the logo mat 335 into the weld area of the first portion of the belt blank 331 in a localized welding zone between the horn 350 and the anvil 360. In other embodiments, various other ultrasonic weld joint designs may be used such as step joint designs, shear joint designs, tongue and groove designs, and the like.

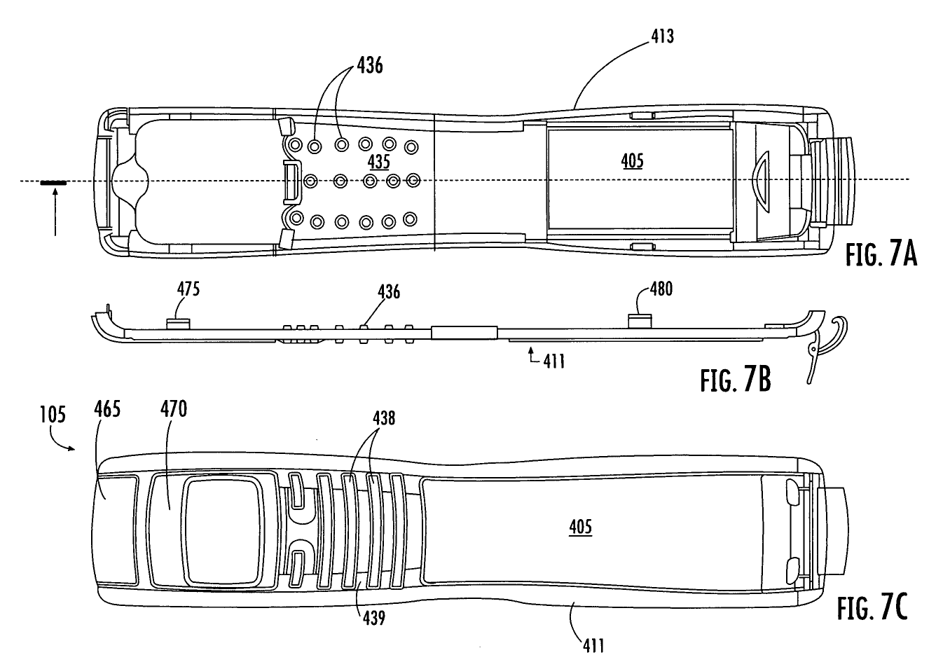

As will be apparent to one of ordinary skill in the art in view of the disclosure above, HF and ultrasonic welding may be used to fuse a variety of additional weldable articles to the belt blank during formation of a mobile station cover. For example, the orthogonal views provided by FIGS. 7A-7C depict embodiments of the invention wherein several weldable articles have been fused to a belt blank using the welding techniques described above. In the depicted embodiment, various aesthetic and functional weldable articles are shown fused to the belt blank 405 portion of a mobile station cover. The aesthetic weldable articles include a logo mat 470 and one or more decorative or aesthetic portions 465 as shown. The functional weldable articles include a key mat 439 having one or more keys 438, a plunger mat 435 having one or more plungers 436, and one or more connector tabs 480 as shown. The key mat 439 or 30 individual keys 438 are positioned to overlie plungers 436 that in turn overlie key contacts of the signal receiving and generating assembly (not shown). Preferably, the key mat 437 or individual keys 438 are constructed of polar plastics having elastic, semi-soft properties, which also may be illuminated by a light source positioned beneath the keys 438. Notably, as will be apparent to one of ordinary skill in the art, the keys 438 and/or plungers 436 may be fused to the belt blank 405 individually despite being depicted in FIGS. 7A-7C as part of integral mats.

In another embodiment, the keys and plungers may extend from a single key/plunger mat (not shown) that is HF or ultrasonic welded within an aperture defined in the belt (not shown). More particularly, the key/plunger mat may include a perimeter tab portion that may be welded to perimeter surface defined about an aperture defined in the belt for receiving the key/plunger mat (not shown). Regardless of the key/plunger structure used, the keys should be capable of at least some movement so that pressure is applied by the plungers to the underlying key contacts.

Covers having weldable articles fused thereto according to various embodiments of the invention provide several advantages over the prior art. For example, such covers may be readily attached and removed from the signal receiving and generating assembly, allowing quick exchange with other covers to change the appearance of the mobile station. Aesthetically pleasing articles (logos, colored panels, etc.) may be welded to such covers to provide enhanced customization of the mobile station's appearance. Alternatively, functional articles such as keymats, padding panels, and the like may be welded to the cover to enhance the operation, impact resistance, and/or durability of the mobile station. Each of the aesthetic and functional weldable articles may be strategically placed on belts in various embodiments to fit differing mobile station structures without interfering with standard mobile station components (e.g, display, speaker, microphone, etc.). Finally, the relative efficiency and simplicity of HF and ultrasonic welding processes allow for rapid customization of mobile station covers by mobile station cover manufacturers.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A mobile station cover, comprising:
a belt adapted to at least partially enclose a wireless telecommunication signal receiving and generating assembly; and
a weldable article fused to the belt at least partially by welding.

2. The mobile station cover of claim 1, wherein the weldable article is an aesthetic article.

3. The mobile station cover of claim 1, wherein the weldable article is a functional article.

4. The mobile station cover of claim 1, wherein the belt is comprised at least partially of polar plastic materials.

5. The mobile station cover of claim 4, wherein the weldable article is fused to the belt via high frequency welding.

6. The mobile station cover of claim 1, wherein the weldable article is comprised at least partially of polar plastic materials.

7. The mobile station cover of claim 6, wherein the weldable article is fused to the belt via high frequency welding.

8. The mobile station cover of claim 1, wherein the belt is comprised of a base layer and a weld layer and wherein the weldable article is fused to the weld layer of the belt via high frequency welding.

9. The mobile station cover of claim 8, wherein the weld layer of the belt is comprised at least partially of polar plastic materials.

10. The mobile station cover of claim 1, wherein the weldable article is fused to the belt via ultrasonic welding.

11. A mobile station, comprising:
a wireless telecommunication signal receiving and generating assembly;
a mobile station cover comprising a belt having a first portion, a second portion, and a foldable portion defined therebetween, wherein the foldable portion accommodates separation of the first portion from the second portion in an open position for receiving and at least partially enveloping the wireless telecommunications signal receiving and generating assembly; and
a weldable article fused to the belt at least partially by welding.

12. The mobile station of claim 11, wherein the weldable article is an aesthetic article.

13. The mobile station of claim 11, wherein the weldable article is a functional article.

14. The mobile station of claim 11, wherein the belt is comprised at least partially of polar plastic materials.

15. The mobile station of claim 14, wherein the weldable article is fused to the belt via high frequency welding.

16. The mobile station of claim 11, wherein the weldable article is comprised at least partially of polar plastic materials.

17. The mobile station of claim 16, wherein the weldable article is fused to the belt via high frequency welding.

18. The mobile station cover of claim 11, wherein the belt further comprises a base layer and a weld layer and wherein the weldable article is fused to the weld layer of the belt via high frequency welding.

19. The mobile station cover of claim 18, wherein the weld layer of the belt is comprised at least partially of polar plastic materials.

20. The mobile station of claim 11, wherein the weldable article is fused to the belt via ultrasonic welding.

21. A method of manufacturing a mobile station cover, the method comprising:
forming a belt having a first portion, a second portion, and a foldable portion defined therebetween, wherein the foldable portion is adapted to allow the first portion to separate from the second portion in an open position for receiving and at least partially enveloping a wireless telecommunication signal receiving and generating assembly; and
fusing a weldable article to the belt at least partially by welding.

22. The method of claim 21, wherein the fusing step is a high frequency welding step comprising the steps of positioning a weld area of the belt comprised at least partially by polar plastics materials and a weld area of the weldable article comprised at least partially of polar plastics materials between a die and a capacitor plate, applying an oscillating electrical field to melt the weld area of the belt and the weld area of the weldable article, and compressing the belt and the weldable article between the die and the capacitor plate to fuse the weld area of the belt and the weld area of the weldable article.

23. The method of claim 21, wherein the fusing step is an ultrasonic welding step comprising the steps of positioning a weld area of the belt and a weld area of the weldable article between a horn structured to generate an acoustic vibration and an anvil, applying an acoustic vibration generated by the horn to melt the weld area of the belt and the weld area of the weldable article, and compressing the belt and the weldable article between the horn and the anvil to fuse the weld area of the belt and the weld area of the weldable article.
